(19) United States
(12) Patent Application Publication
(10) Pub. No.: US 2026/0120682 A1
(43) Pub. Date: Apr. 30, 2026

(54) Contrastive representations of multi-dimensional, structure treatments

(71) Applicant: Spotify AB, Stockholm (SE)

(72) Inventors: Oriol Corcoll Andreu, Stockholm (SE); Athanasios Vlontzos, Stockholm (SE); Michael O'Riordan, Stockholm (SE); Ciaran Lee, Stockholm (SE)

(21) Appl. No.: 18/934,565

(22) Filed: Nov. 1, 2024

(30) Foreign Application Priority Data
Oct. 24, 2024 (GR) 20240100747

(51) Int. Cl. G10L 15/06

(52) U.S. Cl. CPC G10L 15/063

(57) ABSTRACT

Example implementations include identifying, from a plurality of training examples that each include a respective first input, second input, and output, anchor, positive, and negative training examples by: applying the second inputs of the anchor, positive, and negative training examples to a mapping function to generate respective mapped inputs, determining that the mapped inputs of the anchor and positive training examples and the anchor and negative training examples differ by less than a first threshold value, determining that the outputs of the anchor and positive training examples differ by less than a second threshold value, and determining that the outputs of the anchor and negative training examples differ by more than the second threshold value; applying the first and second inputs of the anchor, positive, and negative training examples to a machine learning model to determine a contrastive loss; and updating the machine learning model based on the contrastive loss.

### CROSS-REFERENCE TO RELATED APPLICATION

This application calls priority to Greek non-provisional application No. 20240100747, filed Oct. 24, 2024, the contents of which are hereby incorporated by reference.

### FIELD OF THE INVENTION

The present invention relates to the field of digital audio processing and techniques for selecting digital audio content for stream or other forms of distribution based on contrastive loss. Nonetheless, these techniques have applicability to other fields.

### BACKGROUND

Digital audio content, images, chemical structure graphs, or other multi-dimensional treatments can be used to predict various outcomes, e.g., how a user might respond to particular digital audio content or whether and to what degree a candidate drug will have a desired therapeutic effect. A variety of different machine-learning model architectures and training methods can be used to predict outputs from such multi-dimensional inputs. However, these models are often rendered less accurate when the multi-dimensional inputs are correlated in various ways.

### SUMMARY

Various implementations disclosed herein involve techniques for training machine learning models to make improved, unbiased (or reduced-bias) predictions based on multi-dimensional inputs. Such multi-dimensional inputs often include many aspects (e.g., features) only a subset of which have causal relationships with an output of interest, but that are correlated (e.g., due to being causally affected by a common confounding variable). For example, a digital audio clip or information related thereto (e.g., a spectrogram, a set of features generated therefrom) could include aspects that have a causal effect on a user's response to the audio clip as well as aspects that do not have such a causal effect. However, since both aspects may receive causal effects from a confounding variable that relates to the user's identity (e.g., to the identity of a user account of the user), such causal and non-causal aspects of the input may be correlated. Accordingly, naïve model training methods may erroneously rely on both the causal and non-causal aspects of the input, leading to bias or other unwanted effects on the model and/or predictive outputs generated therefrom.

Thus, it is desirable to identify those aspects of such inputs that are non-causal and restrict them from having significant effects on the predictive output of a trained machine learning model. However, due to their correlation with the causal aspects and other factors, there are numerous technical challenges when attempting to identify which aspects of such an input are causal and which are not.

The embodiments described herein overcome these challenges by using a computationally tractable process to identify, within a set of available training examples, triplets of anchor, positive, and negative training examples. The positive and negative examples are selected such that they are similar to the anchor with respect to the confounding input but differ from each other with respect to the output, with the positive example being similar to the anchor with respect to the output and the negative example being different from the anchor with respect to the output. Such similarity between the confounding inputs can include a clustering, mapping (e.g., nonlinear kernel), or other function of the confounding inputs to allow the confounding inputs to be compared, e.g., by differencing and comparison to a threshold value. Similarity between the outputs can also be evaluated by differencing and comparison to another threshold value. The use of such thresholding also allows more triplets to be identified within a limited training dataset, since it is more likely for training examples to be approximately equal in this manner than to be perfectly identical, especially in applications wherein the confounding variable is multi-variate, sparse, or otherwise broadly distributed.

For such identified triplets of training examples, it can be assumed that the causal aspects of the input are similar between the anchor and positive, and different between the anchor and negative. Thus, a contrastive loss can be generated that can (optionally in combination with a reconstructive loss or other loss information) be used to update or otherwise train a machine learning model to make predictions based more on the causal aspects of the input than on the non-causal aspects (e.g., based substantially not at all on the non-causal aspects). Such a model can exhibit less bias, due to reduced (or no) reliance on the non-causal aspects of the input, and thus can provide improved predictive outputs for novel inputs, including novel inputs outside the distribution represented in the training dataset.

Accordingly, a first example embodiment may involve (i) obtaining a plurality of training examples, wherein each training example of the plurality of training examples includes a first input, a second input, and an output, wherein the first input is multi-dimensional; (ii) identifying an anchor training example, a positive training example, and a negative training example of the plurality of training examples by: (a) applying the second inputs of the anchor training example, positive training example, and negative training example to a mapping function to generate respective mapped inputs, (b) determining that a first difference between the respective mapped inputs of the anchor training example and the positive training example is less than a first threshold value, (c) determining that a second difference between the outputs of the anchor training example and the positive training example is less than a second threshold value, (d) determining that a third difference between the respective mapped inputs of the anchor training example and the negative training example is less than the first threshold value, and (e) determining that a fourth difference between the outputs of the anchor training example and the negative training example is greater than the second threshold value; (iii) applying the first and second inputs of the anchor training example, the positive training example, and the negative training example to a machine learning model to determine a contrastive loss; and (iv) updating the machine learning model based on the contrastive loss.

A second example embodiment may involve applying a first input and a second input to a trained machine learning model to generate an output, wherein the first input is multi-dimensional, and wherein the trained machine learning model has been trained in accordance with the first embodiment.

A third example embodiment may involve a non-transitory computer-readable medium, having stored thereon program instructions that, upon execution by a computing system, cause the computing system to perform operations in accordance with any previous example embodiment.

In a fourth example embodiment, a computing system may include at least one processor, as well as memory and program instructions. The program instructions may be stored in the memory, and upon execution by the at least one processor, cause the computing system to perform operations in accordance with any previous example embodiment.

In a fifth example embodiment, a system may include various means for carrying out each of the operations of any previous example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a block diagram illustrating a media content delivery system, in accordance with example embodiments.

FIG. 2 is a block diagram illustrating an electronic device, in accordance with example embodiments.

FIG. 3 is a block diagram illustrating a media content server, in accordance with example embodiments.

FIG. 4 is a flow chart depicting causal relationships between confounding variables, latent variables, observed inputs, and outputs in a predictive task, in accordance with example embodiments.

FIG. 5A depicts a flow chart of an example method, in accordance with example embodiments.

FIG. 5B depicts a flow chart of an example method, in accordance with example embodiments.

FIG. 6 depicts an algorithm, in accordance with example embodiments.

FIG. 7 depicts elements of an example predictive model, in accordance with example embodiments.

FIG. 8 depicts experimental results, according to example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Media Content Delivery System

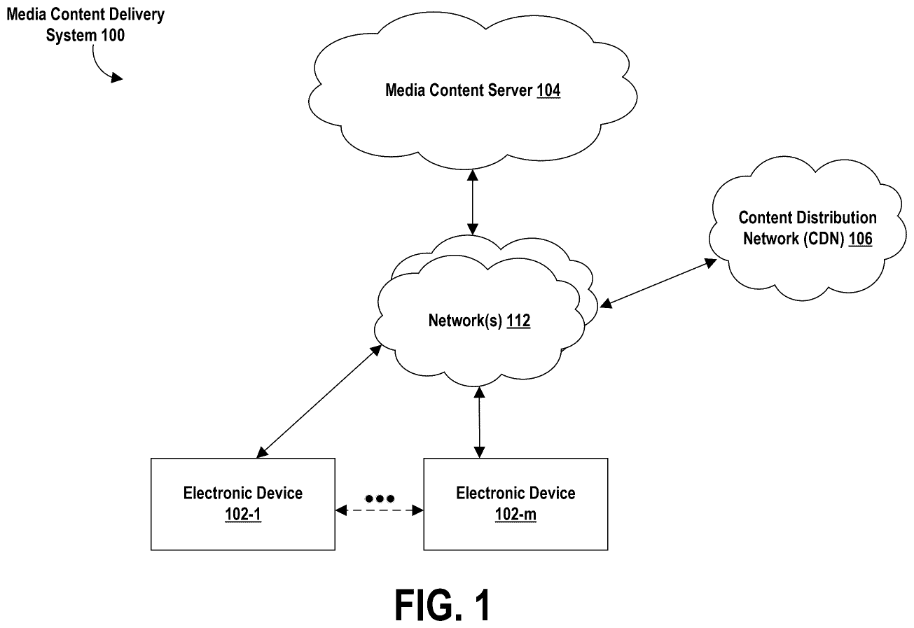

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicatively couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, infotainment system, digital media player, speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items (and possibly the media content items) to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

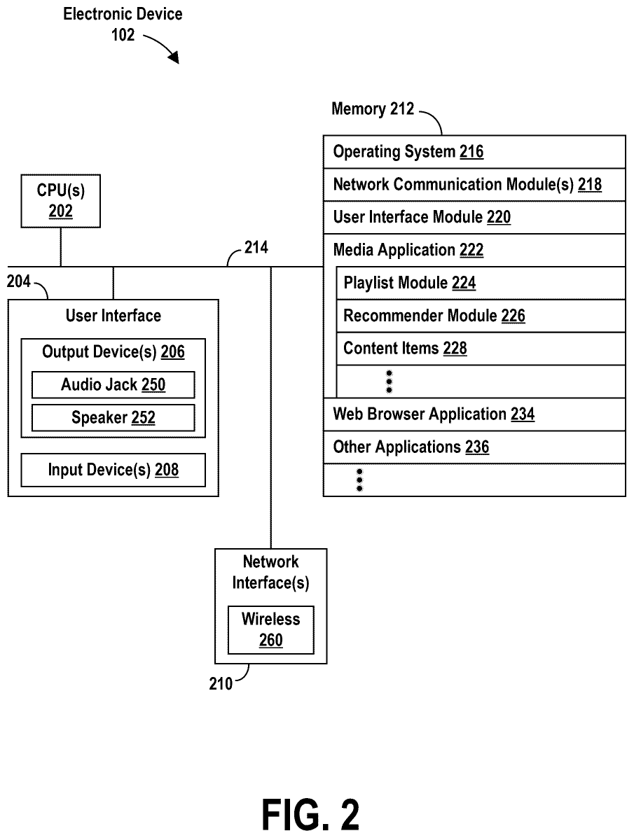

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice application programming interface (API), a connect API, and/or a key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1) in accordance with some embodiments. The electronic device 102 includes one or more central processing units (CPU(s) 202, i.e., processors or cores), one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are conducted using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are conducted using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof: an operating system 216, network communication module(s) 218, a user interface module 220, a media application 222, a web browser application 234, and other applications 236.

The operating system 216 may include procedures for handling various basic system services and for performing hardware-dependent tasks. Network communication module(s) 218 may connect the electronic device 102 to other computing devices (e.g., media presentation system(s), media content server 104, and/or other client devices) via the one or more network interface(s) 210 (wired or wireless) connected to one or more network(s) 112. The user interface module 220 may receive commands and/or inputs from a user via the user interface 204 (e.g., from the input devices 208) and provides outputs for playback and/or display on the user interface 204 (e.g., the output devices 206). Media application 222 (e.g., an application for accessing a media-providing service of a media content provider associated with media content server 104) may provide uploading, browsing, receiving, processing, presenting, and/or requesting playback of media (e.g., media items).

In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof: a playlist module 224, a recommender module 226, and a content items module 228.

The playlist module 224 may store sets of media items for playback in a predefined order. In some embodiments, the playlist module 224 is configured to generate playlists. In some embodiments, the playlist module 224 includes a diffusion model component, a large language model component, and/or a nearest neighbor search component. The recommender module 226 may identify and/or display recommended media items (e.g., to include in a playlist). In some embodiments, the recommender module 226 includes a diffusion model component, a large language model component, and/or a nearest neighbor search component. The content items module 228 may store media items, including audio items such as podcasts and songs, for playback and/or for forwarding requests for media content items to the media content server. In some embodiments, the content item module 228 includes a set of vector representations for the media items.

The web browser application 234 may access, view, and interact with web sites. In doing so, the web browser application 234 may using web-based communication protocols, web-based applications, and/or web-based content formats.

The other applications 236 may include applications for word processing, calendaring, mapping, weather, time keeping, virtual digital assistant, presenting, drawing, instant messaging, e-mail, telephony, video conferencing, photo management, video management, a digital music player, a digital video player, 2D gaming, 3D (e.g., virtual reality) gaming, electronic book reader, and/or workout support.

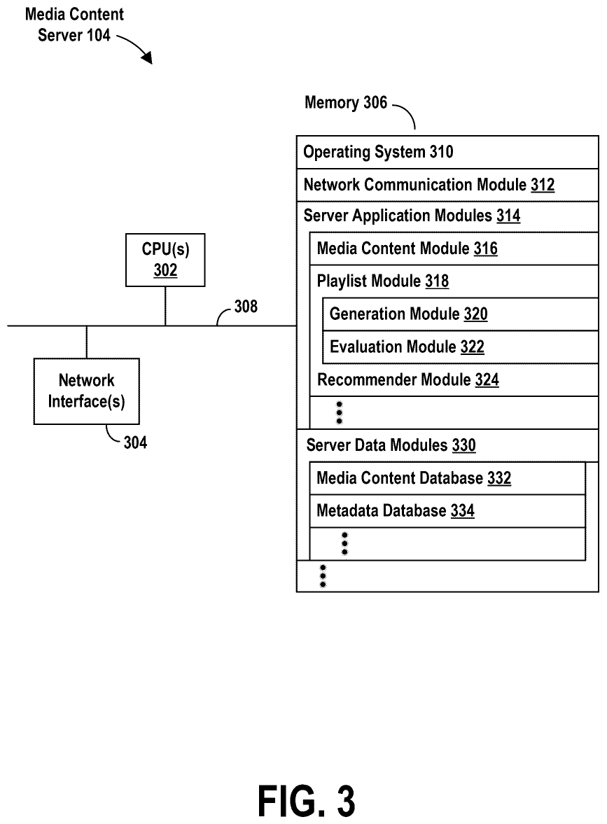

FIG. 3 is a block diagram illustrating a media content server 104 in accordance with some embodiments. The media content server 104 typically includes one or more CPUs 302, one or more network interfaces 304, memory 306, and one or more communication buses 308 for interconnecting these components.

Memory 306 includes high-speed random-access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof: an operating system 310, a network communication module 312, one or more server application modules 314, and one or more server data module(s) 330.

The operating system 310 may include procedures for handling various basic system services and for performing hardware-dependent tasks.

The network communication module 312 may be used for connecting the media content server 104 to other computing devices via one or more network interfaces 304 (wired or wireless) connected to one or more networks 112.

The one or more server application modules 314 may perform various functions with respect to providing and managing a content service, the server application modules 314 including, but not limited to, one or more of: a media content module 316, a playlist module 318, and a recommender module 324.

The media content module 316 may store one or more media content items and/or send (e.g., stream), to the electronic devices, one or more requested media content item(s).

The playlist module 318 may be for storing and/or providing (e.g., streaming) sets of media content items (e.g., to the electronic devices 102). In some embodiments, the playlist module 318 includes one or more of: a generation module 320 for generating playlists and media sets and an evaluation module 322 for evaluating the playlists and media sets, e.g., before and after publication. In some embodiments, the playlist module 318 includes a diffusion model component, a large language model component, and/or a nearest neighbor search component.

The recommender module 324 may determine and/or provide media item recommendations (e.g., for a playlist). In some embodiments, the recommender module 324 includes a diffusion model component, a large language model component, and/or a nearest neighbor search component. In some embodiments, the recommender module 324 includes a model component trained to predict a user's response to an input audio track or other representation of audio or other digital content (e.g., to predict therefrom a user-specific rating, likelihood of skipping, likelihood of replaying or repeating, or other measures of user engagement). Such a model component can be a predictive model as described elsewhere herein, e.g., to predict user response based on a confounding variable (e.g., an identification of a particular user account from a set of user accounts) and a number of predictive factors extracted from the audio file or other digital content (e.g., predictive factors extracted from the digital content while other factors, determined to be non-predictive, are not extracted and/or not used by the model to generate the prediction). This could include using clustering or other projection techniques to map or otherwise project the confounding variable (e.g., user account identifier) into a projection space to facilitate use thereof as an input to the model.

The recommender module 324 and/or some other aspect of the media content server 104 could be configured to train such a predictor model, e.g., using the method described elsewhere herein. This could include identifying, from a set of available sets of digital content files (or multi-dimensional representations thereof), user accounts, and user responses, sets of anchor, positive, and/or negative training examples which could then be applied, along with corresponding contrastive loss information, to train the model. Such a model training process could be performed once (e.g., based on an initial set of training data) or in an ongoing manner (e.g., to periodically update or fine-tune existing trained models, or to train new models, based on newly-acquired training data).

The one or more server data module(s) 330 may manage the storage of and/or access to media items and/or metadata relating to the media items. In some embodiments, the one or more server data module(s) 330 include: a media content database 332 for storing media items and/or vector representations (or other embeddings) for the media items; and a metadata database 334 for storing metadata relating to the media items, such as a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous Javascript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system manages during peak usage periods as well as during average usage periods.

### II. Digital Audio Content and Streaming

Digital audio content, as discussed herein, encompasses a broad range of audio data that has been converted into a digital format, enabling it to be stored, processed, transmitted, and received by electronic devices. This can include spoken word recordings, such as news broadcasts, podcasts, audiobooks, and lectures, which offer listeners a convenient way to consume information and entertainment through auditory means. Additionally, digital audio content can combine spoken word with music or other sounds, creating rich, multi-layered audio experiences commonly found in radio shows, multimedia presentations, and enhanced podcasts. Furthermore, digital audio content often constitutes the audio portion of digital video content, such as the soundtrack of movies, television shows, online videos, and live streams. This integration allows for synchronized audio-visual experiences that enhance the storytelling and engagement of visual media. Digital audio content is typically compressed using various encoding techniques (e.g., MP3, AAC, or Opus) to reduce file size while maintaining quality, and it can be distributed across a multitude of platforms, including streaming services, downloadable files, and broadcasting networks. Digital audio content may also be obtained from audio/video encodings, such as H.264/MPEG-4 or 3GP.

For instance, digital audio content streaming involves transmitting audio data from a media content server 104 to electronic devices 102 over a network 112. At the media content server 104, the process may involve content preparation, where the audio is encoded using compression algorithms (if it is not already compressed). The encoded audio is then segmented into smaller pieces, making it easier to stream continuously. These audio content pieces, along with associated metadata, are stored on the media content server 104. To facilitate delivery, the server may utilize the CDN 106, which caches the audio content pieces on geographically distributed servers, reducing latency and improving reliability. The media content server 104 may employ streaming protocols such as HTTP Live Streaming (HLS), Dynamic Adaptive Streaming over HTTP (DASH), or the Real-Time Messaging Protocol (RTMP) to transmit the audio segments. These protocols manage the data transmission and adapt to varying network conditions. Additionally, the media content server 104 handles user sessions, managing requests for specific audio streams and providing secure access through authentication and authorization mechanisms.

On the receiving end, electronic devices 102 may initiate a connection to the media content server 104 by requesting a specific audio stream. After receiving the initial audio segments, the electronic device 102 begins buffering, pre-loading a portion of the audio into memory to provide smooth playback even in the case of minor network interruptions. The buffered pieces are then decoded from their compressed format back into an audio signal by media player software of the electronic device 102. Adaptive streaming protocols, such as those discussed above, allow the electronic device 102 to monitor network conditions and request different quality levels of digital audio content based on current bandwidth availability, thus providing consistent playback without interruptions in most cases. The electronic device 102 also handles network errors and interruptions by attempting to reconnect to the media content server 104, re-buffering when necessary, and dynamically adjusting the stream quality to maintain a continuous audio experience. The decoded audio may be played through the electronic device 102 (e.g., via speakers or headphones), with the media player software managing playback controls like play, pause, skip, and volume adjustment.

### III. Example Machine Learning Models

As discussed above, the embodiments herein may employ neural networks or other machine learning models to, e.g., predict the effect of digital media content (e.g., an audio clip), a drug, or some other multi-dimensional treatment on an output (e.g., an indication of a user level of engagement with the digital media content, a clinical efficacy of an applied drug) in the face of a predictive, confounding input (e.g., an index, UUID, or other information sufficient to specify, from a set of user accounts, the user account of a user of a computer systems or a patient of a healthcare system). A machine learning model as described herein may include, but is not limited to: an artificial neural network (e.g., a convolutional neural networks, a recurrent neural network, a Bayesian network), a hidden Markov model, a Markov decision process, a logistic regression function, a support vector machine, a suitable statistical machine learning algorithm, a heuristic machine learning system, a transformer or other model that includes an attention mechanism and/or that operates on sets of tokens in a multi-layer manner, a large language model, a support vector machine, a regression tree, an ensemble of regression trees (also referred to as a regression forest), a decision tree, an ensemble of decision trees (also referred to as a decision forest), and/or some other machine learning model architecture or combination of architectures.

An artificial neural network (ANN) could be configured in a variety of ways. For example, the ANN could include two or more layers, could include units having linear, logarithmic, or otherwise-specified output functions, could include fully or otherwise-connected neurons, could include recurrent and/or feed-forward connections between neurons in different layers, could include filters or other elements to process input information and/or information passing between layers, or could be configured in some other way.

An ANN could include one or more filters that could be applied to the input and the outputs of such filters could then be applied to the inputs of one or more neurons of the ANN. For example, such an ANN could be or could include a convolutional neural network (CNN). Convolutional neural networks are a variety of ANNs that are configured to facilitate ANN-based classification or other processing based on images or other large-dimensional inputs whose elements are organized within two or more dimensions. The organization of the ANN along these dimensions may be related to some structure in the input structure (e.g., as relative location within the two-dimensional space of a spectrogram can be related to similarity between frequency content of an audio clip at similar points in time).

In example embodiments, a CNN includes at least one two-dimensional (or higher-dimensional) filter that is applied to an input; the filtered input is then applied to neurons of the CNN (e.g., of a convolutional layer of the CNN). The convolution of such a filter and an input could represent the color values of a pixel or a group of pixels from the input, in embodiments where the input is an image, or the time-varying contents of an audio clip at varying frequencies where the input is audio content. A set of neurons of a CNN could receive respective inputs that are determined by applying the same filter to an input. Additionally or alternatively, a set of neurons of a CNN could be associated with respective different filters and could receive respective inputs that are determined by applying the respective filter to the input. Such filters could be trained during training of the CNN or could be pre-specified. For example, such filters could represent wavelet filters, center-surround filters, biologically-inspired filter kernels (e.g., from studies of animal visual processing receptive fields), or some other pre-specified filter patterns.

A CNN or other variety of ANN could include multiple convolutional layers (e.g., corresponding to respective different filters and/or features), pooling layers, rectification layers, fully connected layers, or other types of layers. Convolutional layers of a CNN represent convolution of an input (e.g., of a filtered, downsampled, or otherwise-processed version of an input audio clip or other input), with a filter. Pooling layers of a CNN apply non-linear downsampling to higher layers of the CNN, e.g., by applying a maximum, average, L2-norm, or other pooling function to a subset of neurons, outputs, or other features of the higher layer(s) of the CNN. Rectification layers of a CNN apply a rectifying nonlinear function (e.g., a non-saturating activation function, a sigmoid function) to outputs of a higher layer. Fully connected layers of a CNN receive inputs from many or all of the neurons in one or more higher layers of the CNN. The outputs of neurons of one or more fully connected layers (e.g., a final layer of an ANN or CNN) could be used to determine information about areas of an input image (e.g., for each of the pixels of an input image) or for the image as a whole.

To generate a machine learning model, the model can be trained and, once trained, used to perform inference on novel inputs. A variety of machine learning training techniques are available that involve training one or more machine learning algorithms on an input set of training data to recognize patterns in the training data and provide output inferences and/or predictions about (patterns in the) training data. Such output could take the form of predicted effects of the input on a process, e.g., a degree of engagement (measured as a user rating, the user not skipping a track, or the user adding a track to a personal playlist) likely to be experienced by a listener when listening to audio content represented by the input, or a predicted clinical effect of a drug represented (e.g., as a chemical graph) by the input. The resulting trained machine learning algorithm can be termed as a trained machine learning model. In a ‘training phase,’ one or more machine learning algorithms can be trained on training data to become trained machine learning model. Then, during an ‘inference phase,’ a trained machine learning model can receive input data and one or more inference/prediction requests (perhaps as part of input data) and responsively provide as an output one or more inferences and/or predictions.

As such, trained machine learning model(s) can include one or more models of one or more machine learning algorithms. In some examples, machine learning algorithm(s) and/or trained machine learning model(s) can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) and/or trained machine learning model(s). In some examples, trained machine learning model(s) can be trained, reside, and execute to provide inferences on a particular computing device, and/or otherwise can make inferences for the particular computing device.

During training phase, machine learning algorithm(s) can be trained by providing at least training data as training input using unsupervised, supervised, semi-supervised, and/or reinforcement learning techniques. Unsupervised learning involves providing a portion (or all) of training data to machine learning algorithm(s) and machine learning algorithm(s) determining one or more output inferences based on the provided portion (or all) of training data. Supervised learning involves providing a portion of training data to machine learning algorithm(s), with machine learning algorithm(s) determining one or more output inferences based on the provided portion of training data, and the output inference(s) are either accepted or corrected based on correct results associated with training data. For example, one or more loss terms can be determined based on the output inference(s) and used to update or otherwise train the machine learning algorithm(s). Such loss terms can include reconstructive loss terms related to the ability of the algorithm(s) to accurately match the correct results. Such loss terms can also include additional terms (e.g., used in weighted combination with each other and/or with reconstructive loss terms to update the algorithm(s)) in order to apply some additional constraints or considerations to the performance and behavior of the algorithm(s). For example, a contrastive loss term as described herein could be determined and used in order to generate machine learning algorithm(s) that accurately make predictions based only (or primarily) on the causal aspects of an input and not (or substantially not) on the non-causal aspects of the input. In some examples, supervised learning of machine learning algorithm(s) can be governed by a set of rules and/or a set of labels for the training input, and the set of rules and/or set of labels may be used to correct inferences of machine learning algorithm(s).

Once the training phase has been completed, trained machine learning model(s) can be provided to a computing device, if not already on the computing device. Inference can begin after trained machine learning model(s) are provided to computing device. During inference phase, trained machine learning model(s) can receive input data and generate and output one or more corresponding inferences and/or predictions about input data. As such, input data can be used as an input to trained machine learning model(s) for providing corresponding inference(s) and/or prediction(s). For example, trained machine learning model(s) can generate inference(s) and/or prediction(s) in response to one or more inference/prediction requests. In some examples, trained machine learning model(s) can be executed by a portion of other software. For example, trained machine learning model(s) can be executed by an inference or prediction daemon to be readily available to provide inferences and/or predictions upon request. Input data can include data from a computing device executing the trained machine learning model(s) and/or input data from one or more other computing devices.

### IV. Example Contrastive Representations of Multi-Dimensional Inputs and Related Machine Learning Model Training Methods

Multi-dimensional inputs (e.g., images, audio content, drug chemical structures) can have highly structured or otherwise redundant contents, making it difficult to determine which aspects of the input have an actual causal relationship with an output to be predicted. As a result, naïve model training using such inputs as training data can result in models that exhibit significant bias and that exhibit reduced accuracy when generalizing to inputs that significantly differ from those used during training, requiring larger, and more varied, training datasets and more extensive training processes. This can result in increased storage, power, memory, and other requirements to accomplish such training processes. These shortcomings can be related to the difficulty in identifying and separating the causal and non-causal aspects of such structured multi-dimensional inputs. This difficulty can be increased when the causal and non-causal aspects are correlated in some way, e.g., when both the causal and non-causal aspects of a multi-dimensional input exhibit causal relationships with a common confounding variable or other input(s). For example, when the confounding variable is the identity of a user account of an audio streaming service, the features underlying multi-dimensional audio content presented for play to the user account are all likely correlated with that user account variable. However, only a subset of the features of the audio content will be causally predictive of the user's engagement of the audio content.

Additionally, model inference on large, multi-dimensional inputs implicates increased computational costs (e.g., memory to execute such a model, storage to maintain the additional parameters of such a model, computational cycles, and thus power, needed to execute such a model). Identifying which features or other contents of a large input are causally related to a predicted output, and which are not, can allow the size of the input to be restricted to those features (or other aspects) of the input that are causal to the output (or, at least likely to be causal), resulting in reduced computational and power costs to generate predicted outputs therefrom.

Various implementations disclosed herein involve techniques for enhancing training of predictive models to accept structured, multi-dimensional inputs and related confounding inputs by adding a contrastive loss term. Doing so allows the model to be trained to emphasize the predictive contributions of aspects of the multi-dimensional input that have causal effects on the predicted output and de-emphasize aspects of the input that are non-causal to the output but that are merely correlated with the causal factors (e.g., due to both sets of aspects of the multi-dimensional input being causally dependent on the confounding input). This results in model training processes that exhibit higher accuracy and that are more readily generalizable to novel inputs while requiring less training data and less computational cost (e.g., processor cycles and thus power).

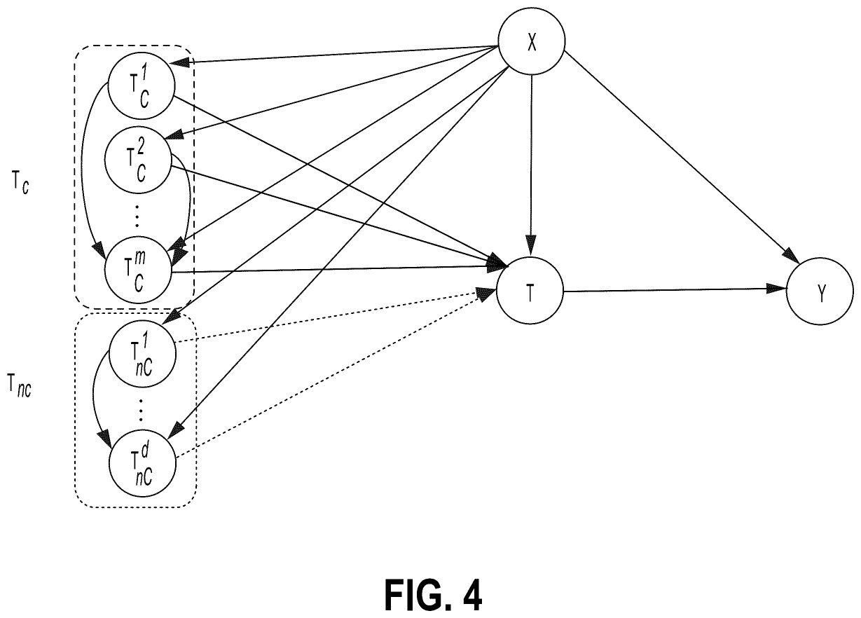

To illustrate this situation, FIG. 4 depicts a graph of various variables of interest and their relationships. “X” and “T” are observable inputs, and “Y” is an output to be predicted. T is a multi-dimensional input (e.g., an audio clip, a graph representing the structure of a drug candidate), X is an observable confounding variable (e.g., the identity of a user account or patient), and Y is some output of interest (e.g., a patient's response to a drug candidate, whether a user will highly rate, listen to the end, favorite, repeat, add to a playlist, or otherwise engage with an audio or video clip). T is causally related to both “Tc” features (‘c’ for causal) and “Tnc” features (‘nc’ for non-causal); but only the portions of T related to Tc have causal effects on Y. X has direct causal effects on Y, as well as causal effects on the Tc and Tnc features.

There are numerous technical challenges with using training datasets of X, T, and Y that are related in this manner to train a model to predict the Y from T and X. For instance, because the Tc and Tnc portions of the observable multi-dimensional input are both causally related to X, they are likely to be correlated. As a result, naively training a model (e.g., a neural network model, a deep learning model, a transformer, or some other variety of machine learning model) to predict Y from T and X is likely to result in bias, inaccuracy, and difficulty in maintaining model performance for novel inputs that are dissimilar to the inputs represented in the training dataset. Additionally, the computational cost to train and/or execute such a model for inference is likely to be increased, since some portion of an input T does not have causal effects on Y is redundant. However, since the model has been trained on the entire input T (e.g., on all of the elements, features, vectors, or other aspects of T), performing inference using the entire T thus represents wasted power or other wasted computational resources (e.g., increased memory, storage, and/or processor cycles) for a given level of model performance (e.g., accuracy).

The implementations herein include methods for generating a contrastive loss term that provides a model training algorithm with additional information to learn which aspects of T are causal with respect to the output Y. This allows the model to de-emphasize or even completely disregard the non-causal aspects of T in its predictions, reducing bias and allowing the model to learn the structure in the input T that is predictive of Y. Accordingly, a model trained with such a contrastive loss can obtain better accuracy using fewer training examples and can exhibit reduced bias, leading to improved performance on novel inputs. Such a contrastive loss is used in combination with, e.g., a reconstructive loss term related to the ability of the model to accurately generate a prediction of the true Y for a given X and T.

Such a contrastive loss can be generated by comparing an anchor training example (Xa, Ta, Ya) to a positive (Xp, Tp, Yp) and a negative (Xn, Tn, Yn) training example in a training dataset. The positive and negative examples are selected such that the contrastive loss determined from them and the anchor (e.g., a triplet loss) is decreased when the model being trained predicts an output for the anchor that is more similar to the output for the positive than to the output for the negative. The positive and negative training examples are identified for a given anchor such that it is expected that the positive is more likely to have the same (or similar) Tc features, relative to the anchor, than the negative. This can be accomplished by, for a given anchor, searching the training dataset for other training examples having the same (or similar) X and the same (or similar) Y for the positive, and the same (or similar) X and different Y for the negative. This distinction, with the X similar and the Y different, makes it more likely that the differences in the T of the positive and negative examples represent differences in the causal Tc, providing the model with this additional contrastive information to learn to distinguish the causal Tc within the observed T from the non-causal TnC.

However, in practice, identifying triplets of training examples that are similar and different with respect to these variables can be very difficult. For example, in small datasets, such triplets of training examples may be very rare (or nonexistent), requiring the use of larger training datasets in order to extract sufficient numbers of such related sets of examples. Acquiring, maintaining, and manipulating such increased-size datasets implicates increased information storage, memory, processing (and thus power), and other costs. Additionally, where the “X” inputs are multi-dimensional, sparse (e.g., a categorical variable like an index number, UUID, or other information to identify a user account from a set of user accounts that can have a great many possible values, but with a broad distribution across the set of possible values), or otherwise distributed such that similarity is difficult to assess and/or exact identity is rare, this problem can be exacerbated further, with the incidence rate of the specified triplets within a training dataset being even less. Further, where the X inputs are multi-dimensional or otherwise complex, it can be computationally expensive to perform any comparison operation (e.g., performing a pairwise similarity comparison for each element, vector, feature, or other aspect of a multi-aspect input).

The embodiments described herein address these issues and to facilitate the efficient identification of sufficient numbers of such positive and negative training examples within a training dataset, even within relatively small datasets. These improvements can be obtained by considering the Y for a given pair of training examples to be similar if a difference therebetween is less than (or equal to) a threshold difference value, and dissimilar otherwise. Similarly, determining whether the X for a given pair of training examples are similar can be efficiently accomplished by projecting or otherwise mapping the X to mapped versions thereof (e.g., scalar variables in a continuous, one-dimensional metric space, single-valued cluster identities) that are more amenable to direct comparison. This can also result in more sets of similar training examples being identified within a given training dataset. A given pair of training examples are then determined to be similar with respect to X if the difference between their respective projected X's (e.g within the one-dimensional metric space), is less than (or equal to) a threshold difference value. So, for a positive pair,

$$\vert g ( Xa ) - g ( Xp ) \vert \leq δ , \vert Ya - Yp \vert \leq ϵ$$

and for a negative pair,

$$\vert g ( Xa ) - g ( Xn ) \vert \leq δ , \vert Ya - yn \vert > ϵ$$

where g(.) is the projection function and δ and ε are threshold values. The projection function can be a clustering function or some other method of projecting confounding variables X (which may be scalars, vectors, tensors or some other form) onto a one-dimensional or otherwise single-valued variable such that similar X are closer, allowing the δ to be used to efficiently identify training examples that are similar with respect to X. In such an examples wherein the projection function is a clustering function (e.g., such that the mapped variables are the identity of the cluster to which the X of a given training example has been assigned), comparison of differences between the mapped X values to a threshold could take the form of determining whether the mapped X values are identical (e.g., whether the mapped X values have been mapped to the same cluster).

These procedures provide a number of technical advantages. For instance, by providing contrastive loss information during training, the resulting trained models can achieve a greater accuracy, with less bias, and with improved performance on novel inputs for a given model size (allowing for reduced memory and/or storage costs) or cost to execute (allowing for reduced processor cycles and thus reduced power use). Additionally, these advantages can be obtained with fewer training examples (allowing for reduced storage costs to maintain such examples and reduced cost of initially obtaining the training examples) and with less overall training effort (allowing for reduced processor cycles/total computational cores and thus reduced bandwidth and reduced power usage). The use of threshold values with respect to similarity between the Y and X, as well as the use of a projection function g(.) to project the X into a space where such comparisons can be efficiently made, facilitates identification of useful positive and negative examples for a greater number of anchor examples than would be possible if relying on more exact correspondences and/or when relying on smaller training datasets, reducing the costs of obtaining such larger training datasets as well as reducing the storage costs of maintaining such datasets and the bandwidth costs of distributing training examples thereof to GPUs or other distributed computational elements using such training data to train a model.

The T input to a model as described herein may take a variety of forms and represent a variety of things. Such an input could include one or more scalars, vectors, matrices, tensors, text or other strings, labels selected from enumerated sets of classes, ordered sets of elements (e.g., mixed, ordered sets of scalars, vectors, tensors, labels, strings), or other elements. Such inputs and/or elements thereof could represent digital audio content (e.g., tracks of music), images, video, drugs or other chemical compounds (e.g., graph(s) representing the chemical structure or other aspects of a chemical compound), or other real, simulated, virtual, or other varieties of physical objects or substances, media, or other things. In some examples, the input could be over-complete or otherwise redundant, e.g., one aspect of the input could include a representation of another aspect of the input. For example, the input could include a first aspect (e.g., an image, an audio clip) and a second aspect that represents the contents of the first aspect, e.g., a lower-dimensional representation of the first aspect, one or more features of the first aspect, a downsampled or otherwise compressed version of the first aspect, a spectrogram, n-dimensional Fourier transform, or other transformed representation of the first aspect, or some other content representative, in whole or in part, of some portion of the first aspect. In some examples, such a second aspect could be determined from the first aspect, e.g., as part of a training data generation process. In some examples, a first aspect of the input could include an audio clip, spectrogram, set of features, and/or some other representation of digital audio or other digital media content and a second aspect of the input could include a title, artist name(s), group name, location or organization of origin, genre identification, information about instruments represented in the media content, or other metadata.

The X input to a model as described herein may take a variety of forms and represent a variety of things. Such an input could include one or more scalars, vectors, matrices, tensors, text or other strings, labels selected from enumerated sets of classes, ordered sets of elements (e.g., mixed, ordered sets of scalars, vectors, tensors, labels, strings), or other elements. Such inputs and/or elements thereof could represent the identity of a user account of a user of a digital media provisioning service, the identity of user account a patient being treated for a disease or condition, medical information about a patient being treated for a disease or condition (e.g., lab results, blood pressure values, demographic information), or other real, simulated, virtual, or other varieties of physical objects or other things.

A mapping function (e.g., the g(.) above) as described herein may take a variety of forms in order to receive inputs of a variety of types (e.g., multi-dimensional inputs, user account or other categorical inputs) and map them to a mapped variable that can be used to determine whether pairs of training examples in a dataset are similar to each other with respect to their X inputs. This could include functions to project a higher-dimensional input to a lower-dimensional (e.g., scalar or otherwise single-dimensional space). Such functions could include linear and/or nonlinear elements, e.g., linear weighted sums of the elements of a vector-valued input, a multi-layer neural network or other nonlinear function or functions, or some other structure of mapping function. Such a mapping function could be determined based on a population of training data, e.g., as a component of a principal components analysis of a population of X inputs, as a row of a projection matrix of a singular value decomposition analysis of a population of X inputs, as a model trained, via unsupervised or semi-supervised methods, to project the input to a single-valued output in a manner that preserves some aspect of structure in the population of X inputs, or some other type of mapping function determined in some other manner based on the population of X inputs. Additionally or alternatively, the mapping function could be wholly or partially determined without reference to a population of X inputs, e.g., as randomly selected nonlinear kernel or other mapping function. The mapping function could be static during use to train a predictive model, or could be updated during the model training process.

In some examples, the mapping function could be a clustering function that assigns X inputs to respective clusters or classes. Such a clustering function could take a multiple-valued input (e.g., a k-means clustering method) or could take single-valued input (e.g., assigning an input that identifies a particular user account of a user, patient, or other entity from a large population of entities and outputs the label or other identity of a group that includes the user account of the particular user, patient, or other entity). Such a clustering function could be determined based on a population of X inputs (e.g., as a set of cluster centroids or other cluster-defining information determined for the population by using a k-means clustering algorithm or other method) and/or auxiliary information (e.g., an assignment of users, patients, or other entities to respective groups based on similarity between the users', patients', or other entities' media preferences, past responses to medical treatments, or patterns in some other auxiliary information about the users, patients, or other entities).

A model trained to predict outputs from two (or more) inputs as described herein could take a variety of forms. For example, such a model could be or include an ANN, a CNN, a regression tree, a regression forest, a transformer, a large language model, or some other predictive structures or combinations of structures. For example, the model could be configured such that (i) the first input is applied to a first sub-model (e.g., a single- or multi-layer artificial neural network) to generate a first intermediate output (e.g., a vector embedding or other representation of the first input), (ii) the second input is applied to a second sub-model (e.g., a single- or multi-layer artificial neural network) to generate a second intermediate output (e.g., a vector embedding or other representation of the second input), and (iii) the first and second intermediate outputs are applied, as inputs, to a third sub-model (e.g., a single- or multi-layer artificial neural network) to generate the overall output of the model.

The model could be trained using a variety of training methods (e.g., stochastic gradient descent) based on one or more loss terms or other sources of error information (e.g., based on a weighted combination of a contrastive loss term determined using a triplet of anchor, positive, and negative training examples and a reconstructive loss term determined based on the ability of the model to accurately predict the correct output for the anchor training example). The particulars of the training method could be static across the entire training process or could change (e.g., based on a number of iterations of the training process having taken place, based on an average accuracy of the model under training over time). For example, the thresholds used to determine whether the X and Y are similar between an anchor training example and candidate positive/negative training examples could decrease over time (e.g., to allow less similar examples to be used to train the model initially when it is less competent, gradually becoming stricter as the model gains training) and/or a weighting factor used to weight the relative importance of the contrastive and reconstructive losses (e.g., to emphasize training the model to reconstruct output during an initial phase before increasing the emphasis on the contrastive loss, to train the model to rely on causal rather than non-causal aspects of the inputs). A portion of the training could be performed without a contrastive loss at all (e.g., to bring the model to a minimal competence with respect to reconstruction) before adding the contrastive loss in a later training phase.

The Y output of a model as described herein may take a variety of forms and represent a variety of things. Such an output could be a continuous-valued output, a discrete-valued output, a categorical output (e.g., an output representing the identity of a class selected from an enumerated list of classes), a non-negative output, a binary-valued output, or some other variety of output. Such an output could represent a user-submitted rating, a likelihood that the user listens or otherwise perceives digital media content all the way to the end or to some specified percent or duration, a likelihood that the user skips the digital media content, a likelihood that the user provides positive (or negative) feedback for the digital media content, a likelihood that a user subscribes to an artist, channel, or other thing related to the digital media content, a likelihood that the user adds the digital media content to a playlist or other collection of media, a likelihood that the user re-listens to or re-watches the digital media content, or some other indicator of a user's engagement with digital media content. The output could represent a degree of efficacy of a drug or treatment, a likelihood that a patient exhibits a positive (or negative) intended effect, side effect, or other effect of a drug or treatment, or some other indicator of the effect of a drug or treatment on a patient. The output could represent some other real, simulated, virtual, or other variety of effect or output related to one or more inputs.

A contrastive loss can be determined and used to train a model as described herein in a variety of ways, such that the model is trained to make inferences based preferentially (or even only) on causal aspects of an input (and less, or not at all, based on non-causal aspects of the input). This could include applying the inputs of each training example in a triplet (anchor, positive, and negative) to the model to generate respective outputs, and then determining the contrastive loss based on whether the predicted output for the anchor was more similar to the predicted output for the positive or the negative training examples. This could include determining respective differences between the anchor prediction and the positive and negative predictions and then determining the contrastive loss based on those predictions. For example, the contrastive loss could be a binary-valued loss with a ‘high’ value (e.g., ‘1’ or ‘TRUE’”) if the absolute value of the difference between the anchor and positive predictions is less than the absolute value of the difference between the anchor and negative predictions, and a ‘low’ value otherwise (e.g., ‘0,’ ‘−1,’ or ‘FALSE’). In another example, the contrastive loss could represent a continuous-valued measure of how much more (or less) similar the model predicts the outputs of the anchor and positive relative to the anchor and negative, e.g., a difference between the absolute value of the difference between the positive and anchor predictions and the absolute value of the difference between the anchor and negative predictions.

Updating or otherwise training the model based on such a contrastive loss could take a variety of forms. For example, updating the model based on the contrastive loss could include updating the model such that the model predictions for the anchor and positive training examples are more similar and/or such that that model predictions for the anchor and negative training examples are less similar. Additionally or alternatively, the contrastive loss could be used to identify, within the input, aspects (e.g., elements of a vector or other tensor, features of a set of features, key/value pairs in metadata) that are or are not causal with respect to the predicted output, and biasing the model toward prediction based on the causal aspects (or away from prediction based on the non-causal aspects). This could include adjusting an attention or other bias for the various aspects, or even removing the non-causal aspects entirely as inputs to the model.

Such an updating process, based on the contrastive loss, could be performed repeatedly or at a limited number of points during the model training process. Additionally or alternatively, an input selection process could be applied to the model (at the end of training and/or at one or more points during the training) to identify the degree to which the model relies on various aspects of the input to make predictions. Those aspects that are less used by the model could then be removed as functional inputs to the model (e.g., by removing aspects of the model that receive such aspects as an input and, for subsequent uses of the model, removing such aspects from the input prior to application of the input to the model).

### V. Example Operations

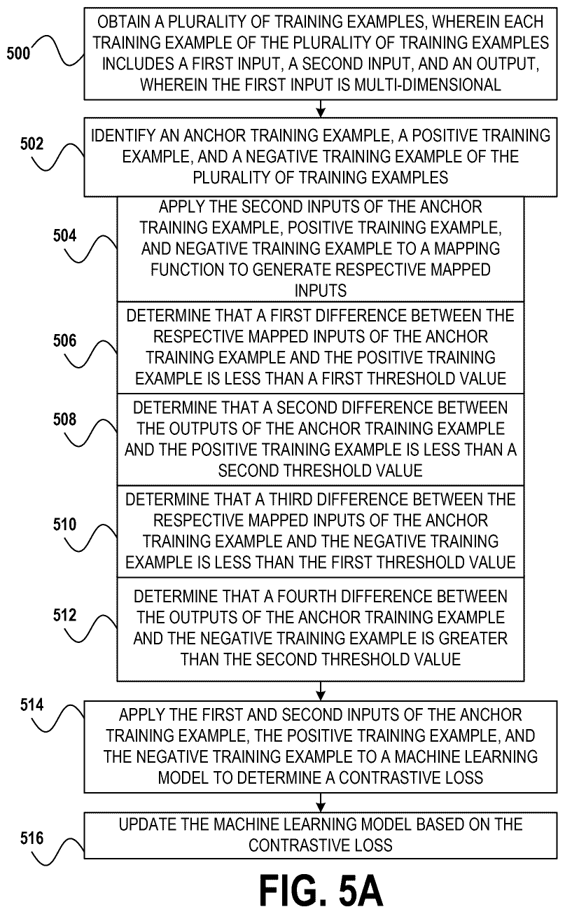

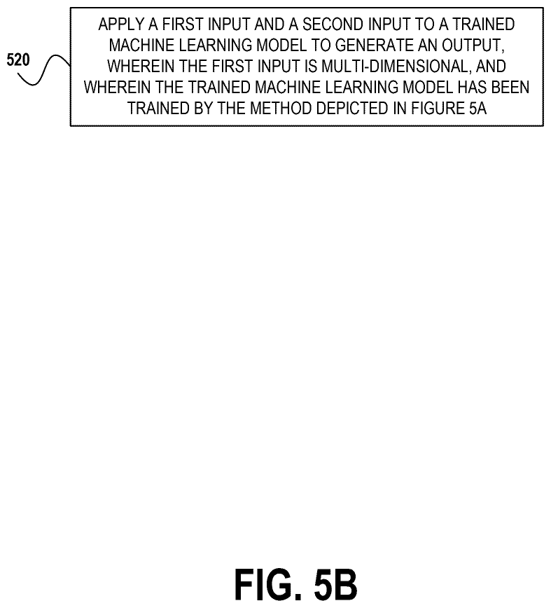

FIG. 5A is a flow chart illustrating an example embodiment. The process illustrated by FIG. 5A may be carried out by a computing device, such as media content server 104, and/or one or more additional computing devices arranged to prepare digital audio content. Alternatively, the process can be carried out by other types of devices or device subsystems.

The embodiments of FIG. 5A may be simplified by the removal of any one or more of the features shown therein. Further, these embodiments may be combined with features, aspects, and/or implementations of any of the previous figures or otherwise described herein.

Block 500 may involve obtaining a plurality of training examples, wherein each training example of the plurality of training examples includes a first input, a second input, and an output, wherein the first input is multi-dimensional.

Block 502 may involve identifying an anchor training example, a positive training example, and a negative training example of the plurality of training examples. This can include, at block 504, applying the second inputs of the anchor training example, positive training example, and negative training example to a mapping function to generate respective mapped inputs. This can also include, at block 506, determining that a first difference between the respective mapped inputs of the anchor training example and the positive training example is less than a first threshold value. This can yet further include, at block 508, determining that a second difference between the outputs of the anchor training example and the positive training example is less than a second threshold value. This can still further include, at block 510, determining that a third difference between the respective mapped inputs of the anchor training example and the negative training example is less than the first threshold value. This can also include, at block, 512, determining that a fourth difference between the outputs of the anchor training example and the negative training example is greater than the second threshold value.

Block 514 may involve applying the first and second inputs of the anchor training example, the positive training example, and the negative training example to a machine learning model to determine a contrastive loss.

Block 516 may involve updating the machine learning model based on the contrastive loss.

FIG. 5B is a flow chart illustrating an example embodiment. The process illustrated by FIG. 5B may be carried out by a computing device, such as media content server 104, and/or one or more additional computing devices arranged to prepare digital audio content. Alternatively, the process can be carried out by other types of devices or device subsystems.

The embodiments of FIG. 5B may be simplified by the removal of any one or more of the features shown therein. Further, these embodiments may be combined with features, aspects, and/or implementations of any of the previous figures or otherwise described herein.

Block 520 may involve applying a first input and a second input to a trained machine learning model to generate an output, wherein the first input is multi-dimensional, and wherein the trained machine learning model has been trained by the method illustrated in FIG. 5A.

The embodiments of FIGS. 5A and/or 5B may be further enhanced by the inclusion of one or more of the features described below. These one or more features may be included in any reasonable combination thereof, including any reasonable subset of the one or more features.

In some embodiments, the first input represents digital audio content and the second input identifies a user account from a set of user accounts. In such embodiments, the first input can include a plurality of features representative of digital audio content.

In some embodiments, updating the machine learning model based on the contrastive loss includes updating the machine learning model such that predicted outputs of the model for the anchor training example and positive training example are less different and further such that predicted outputs of the model for the anchor training example and negative training example are more different.

In some embodiments, determining the contrastive loss includes: (i) applying the first inputs and second inputs of the anchor training example, positive training example, and negative training example to the machine learning model to generate respective predicted outputs; and (ii) determining the contrastive loss based on the predicted outputs. In such embodiments, the method can additionally include determining a reconstructive loss based on the output and predicted output for the anchor training example, and updating the machine learning model based on the contrastive loss can include updating the machine learning model based on the contrastive loss and the reconstructive loss. In such embodiments, determining the contrastive loss based on the predicted outputs can include determining whether a magnitude of a first difference between the predicted outputs for the anchor training example and the positive training example is less than a magnitude of a second difference between the predicted outputs for the anchor training example and the negative training example.

In some embodiments, the method additionally includes, after updating the machine learning model based on the contrastive loss: (i) determining at least one aspect of the first input that the machine learning model relies on less than a threshold amount to generate a model output; and (ii) modifying the machine learning model to not use the determined at least one aspect of the first input to generate the model output.

In some embodiments, the mapping function includes a clustering function.

In some embodiments, the mapping function includes a nonlinear function that projects a multi-dimensional input to a scalar output.

In some embodiments, the first input is representative of a first set of variables and a second set of variables, a variable represented by the second input has a causal effect on the first set of variables, the second set of variables, and the output, the first set of variables has a causal effect on the output that is greater than a causal effect on the output by the second set of variables, and the first set of variables has a causal effect on the output that is greater than a causal effect on the output by the second set of variables.

### VI. Experimental Results

The embodiments described herein were implemented and experimentally validated. The example embodiment that was experimentally validated is described in greater detail below.

A framework was adopted to define the various inputs and outputs of the target prediction task. Such a framework specifies a set of latent variables U={u₁, . . . , uₙ} distributed as P(U), a set of observable variables X={X₁, . . . , Xₘ}, a directed acyclic graph (DAG) G, called the causal structure of the model, whose nodes are the variables U∪X, a collection of functions F=={ƒ₁, . . . , ƒₙ}, such that Xᵢ=ƒᵢ(PA(Xᵢ),uᵢ), for i=1, . . . , n, where PA denotes the parent observed nodes of an observed variable.

A (hard) intervention on variable T is denoted by do(T=1), and it corresponds to removing all incoming edges in the causal graph and replacing its structural equation with a constant.

One causal quantity of interest to the predictive task described herein is the conditional average treatment effect (CATE), which corresponds to the change in outcome for different treatments T,T′ at covariate value x:

$$τ ( T , {T}^{′} , x ) := 𝔼 ( Y \vert do ( {T}^{′} ) , X = x ) - 𝔼 ( Y \vert do ( {T}^{′} ) , X = x )$$

When confounders are observed and d-separate treatment and outcome, the CATE can be estimated via back-door adjustment as follows:

$$τ ( T , {T}^{′} , x ) = 𝔼 ( Y \vert T , X = x ) - 𝔼 ( Y \vert {T}^{′} , X = x ) .$$

The target predictive tasks described herein can be characterized as one in which the object describing the treatment (e.g., an digital audio clip, metadata associated therewith, or representation thereof, a graph representing the chemical structure of a drug) is generated by some collection of latent variables which can causally interact with one another. These could be, for instance, latent aspects of a piece of text, such as tone or style, a collection of features representing a video, or the structure of the bonds in a molecule. The causally relevant latent variables can be represented by T_{C}={T_{C}¹, . . . , T_{C}^{m}} and the non-causally relevant latent variables by T_{nC}={T_{nC}¹, . . . , T_{nC}^{d}}. The following structural equations describe the causal relationships between the confounders X (e.g., an identity or other representation of a user account of a user or patient) and the outcome Y:X=l(ϵ_{X}), T_{C}=g(X,ϵ_{TC}), T_{nC}=h(X,ϵ_{TnC}), T=ƒ(T_{C}, T_{nC}) and outcome Y=ƒ(T_{C},X,ϵ_{Y}), where noise terms may be drawn i.i.d. ϵᵢ˜P(ϵᵢ). In the general case, direct access to the latents themselves may not be available (e.g., the latents may be variables in a lower-dimensional space that maps to the higher-dimensional space of the treatment), but some function of them is available. For example, the treatment a specific problem, T, could correspond to a (potentially non-linear) mixture of these latents, T=m(T_{C},T_{nC}). The DAG for this setting is shown in FIG. 4.

As shown in FIG. 4, T depends on both T_{C} and T_{nC} in the structural equations, T=m(T_{C},T_{nC}). However, outcome Y only depends on T through T_{C}:Y=ƒ(T_{C},X,ϵ_{Y}). This is represented graphically by the solid arrow from T_{C} to T, and on to Y, while the arrow from T_{nC} to T is dashed.

In this setting, T_{C} is mapped to a set of T values, indexed by the T_{nC} latents: T_{C}→T_{TC}={T=ƒ(T_{C},T_{nC})}_{TnC}. For causal effect estimation using the observable treatment T to be unbiased, the predicted CATE using T should reproduce the correct CATE with T_{C}. That is:

$$\int {( τ ( {T}_{C} , {T}_{C}^{′} , X ) - τ ( T , {T}^{′} , X ) )}^{2} P ( X ) dX = 0 , ∀ T ∈ {T}_{TC} and {{T}^{′}}^{′} ∈ {T}_{{T}^{′} C} .$$

It can be demonstrated that back-door adjustment with T does not suffice for causal effect estimation, by constructing at least one example where it fails. Consider the following data generation process:

$$X = {ϵ}_{X} , {T}_{C} = α X + {ϵ}_{TC} , {T}_{nC} = β X + {ϵ}_{TnC} ,$$

$$Y = ρ Tc + δ X + {ϵ}_{Y} , and T = [ \begin{matrix}{T}_{C} \\ {T}_{nC}\end{matrix} ]$$

with ϵᵢ˜N(0,σᵢ). This provides a joint distribution P(Y,X,T).

In order to show backdoor adjustment fails, it can be shown that regressing Y onto T and X does not always result in unbiased estimates of the causal effect of T_{C} on Y. This can be accomplished by showing the existence of a model where [symbol] (Y|T,X) is equal to [symbol] (Y|T_{C},X) from the above data generation process, but where τ(T,T′,X) from the model does not equal τ(T_{C}, T_{C}′,X) from the data generation process above, where T∈T_{TC} and T′∈T_{TC}. In this case, [symbol] (Y|T,X) does not identify [symbol] (Y|do(T_{C}),X).

Consider the following model for Y:

$$Y = [ \begin{matrix}α & \frac{σ}{2 β}\end{matrix} ] [ \begin{matrix}{T}_{C} \\ {T}_{nC}\end{matrix} ] + \frac{σ}{2} X + {ϵ}_{Y} = [ \begin{matrix}α & \frac{σ}{2 β}\end{matrix} ] T + \frac{σ}{2} X + {ϵ}_{Y}$$

As T_{nC}=βX+ϵ_{TnC} it follows that the expected values for Y given T and X, [symbol] (Y|T,X), generated by this model are equivalent to [symbol] (Y|T_{C},X) from the data generation process above. As [symbol] (Y|T,X)= [symbol] (Y|T_{C},X), this model is a possible solution to regressing Y on T and X. However, by intervening on T_{nC}, the relationship between X and T_{nC} is broken, which reveals that the correct causal model has not been learned. To demonstrate this, consider

$$T = [ \begin{matrix}{T}_{C} \\ {T}_{nC}\end{matrix} ] and {T}^{′} = [ \begin{matrix}{T}_{C} \\ {T}_{nC}^{′}\end{matrix} ] with {T}_{nC} \neq {T}_{nC}^{′} .$$

Here, τ(T_{C}, T_{C},X)=0, but

$$τ ( T , {T}^{′} , X ) = \frac{σ}{2 β} ( {T}_{nC} - {T}_{nC}^{′} ) \neq 0.$$

This may occur for a variety of reasons. For example, since the T_{nC} are proxies for the confounders, X, using them in the estimation can make it appear as though the confounders have been suitably controlled for confounders using the T_{nC}, however, intervening on the T_{nC} breaking the link between T_{nC} and X and reveals that the true confounders have not been appropriately controlled for.

This effect is investigated empirically on both synthetic and real data, demonstrating that back door adjustment of T leads to biased effect estimation.

In order to estimate an unbiased causal effect, the multi-dimensional treatment itself should not be directly used. Instead, a representation of T should be used that does not contain any information (or that contains a limited amount of information) about the non-causal latents. Backdoor adjustment with such a representation would have identified the correct causal effect. Accordingly, a representation of the treatment ψ(T) should be used to estimate causal effects. By learning a representation of T that doesn't depend on the non-causal latents, effect estimation based on such a representation will be unbiased in general.

This can be proven by, e.g., assuming first that ψ(T) contains no information about T_{nC}. Then it must map all T∈T_{TC} to the same value. That is, ψ(T) is a reparametrization of T_{C}, as T_{C} are in one-to-one correspondence with T_{TC}. This also means that ψ(.) preserves interventions on T_{C}, which implies it preserves CATE.

To show the converse, that unbiased CATE implies that ψ(T) contains no information about T_{nC}, consider the following. For the CATE to be unbiased

$$\int {( τ ( {T}_{C} , {T}_{C}^{′} , X ) - τ ( T , {T}^{′} , X ) )}^{2} P ( X ) dX = 0 , ∀ T ∈ {T}_{TC} and {T}^{′} ∈ {T}_{{T}^{′} C} .$$

This means that for T,T′∈T_{TC} with T≠T′:

$$0 = \int {( τ ( {T}_{C} , {T}_{C} , X ) - τ ( T , {T}^{′} , X ) )}^{2} P ( X ) dX = \int {( τ ( T , {T}^{′} , X ) )}^{2} P ( X ) dX$$

As all terms in the integral are positive, for it to be equal to zero each term should be equal to zero. But P(X) is positive on its support set, hence for all X

$$0 = τ ( T , {T}^{′} , X ) = 𝔼 ( Y \vert ψ ( T ) , X ) - 𝔼 ( Y \vert ψ ( {T}^{′} ) , X ) ⇒ 𝔼 ( Y \vert ψ ( T ) , X ) = 𝔼 ( Y \vert ψ ( {T}^{′} ) , X ) , ∀ X and T , {T}^{′} ∈ {T}_{TC}$$

This indicates that ψ(T) and ψ(T) are interventionally equivalent from the point of view of Y. As the only difference between T and T′ are their non-causal latents, then the representation ψ(.) must map all T∈T_{TC} to the same value. Hence it must disregard information about T_{nC}.

Such a representation, having no information about T_{nC}, can be developed in a variety of ways. To describe one example embodiment, consider the structural equations above, with ƒ(.) in Y=ƒ(T_{C},X) being an invertible function. Assume two data points where the X and Y values are the same, but the T's are different: [T,x,y],[T,x,y]. As Y=ƒ(T_{C},X),

$$f ( {T}_{C} , C ) = f ( {T}_{C}^{′} , X ) .$$

As this function is invertible, the causal components of T and T′ are the same. However, data points where the X values are the same, but the Y values are different must have different causal components.

This observation suggests a contrastive algorithm with positive and negative pairs as below should push T with similar T_{C} together, and different T_{C} apart.
Positive pairs: [T,x,y],[T′,x,y] such that T≠T′, and X=X′, and Y=Y′
Negative pairs: [T,x,y],[T′,x,y] such that T≠T′, and X=X′, and Y≠Y′

This provably block identifies the causal components of T. The resulting representation ψ(T) contains all and only (or substantially only) information about T_{C}: there exists an invertible φ:ψ(T)=φ(T_{C}). Assuming a structural causal model represented by the DAG from FIG. 4 and equations X=l(ϵ_{X}), T_{C}=g(X,ϵ_{TC}), T_{nC}=h(X,ϵ_{TnC}), T=m(T_{C}, T_{nC}) and Y=ƒ(T_{C},X), with all functions smooth and invertible with smooth inverses, with noise terms drawn i.i.d. ϵᵢ˜P(G) from smooth distributions that have P(ϵᵢ)>0 almost everywhere. Then the contrastive approach outlined above yields a representation of T that block-identifies the causal latents.

Thus, when data involving two classes of variables is available, if pairs of data points are created with one of the pair being the original view and the other an augmented view, such that a subset of one class is different to the original view, then the class of variables that remains the same can be block identified. The theorem holds as long as the underlying data generating process consists of smooth, invertible functions with smooth inverses, and smooth distributions that are non-zero almost everywhere.

To prove the above, one can show that observation T=(T_{C},T_{nC}) can be “augmented” to get (T_{C}, T_{nC}′), where T_{C} is the same but (possibly some subset of) T_{nC} is not.

Consider two data points where the X and Y values are the same, but the T's are possibly different: [T,x,y],[T,x,y]. Per the above, y=ƒ(T_{C},x)=ƒ(T_{C}′,x). As ƒ is invertible, T_{C}=T_{C}′. What this means is that the causally relevant components of T and T′ are the same when the values of Y and X are the same. But it is also beneficial show that the augmentations have different T_{nC} components. That is, these augmentations leave T_{C} invariant, but change (some subset of) T_{nC}.

If there exists different T, T′ that occurs with the same values of X and Y, then T_{nC} must be different, as the T_{C} is the same. But, in general, must there exist at least two different 7's for some particular values of X and Y? If not, then T_{nC} only depends on X and not the noise term ϵ_{TnC}, which is a contradiction with the starting assumption that P(ϵ_{TnC}) has non-trivial support. Thus, choosing data augmentations in this fashion ensures T_{C} is invariant between augmentations, but T_{nC} not.

Instead of demanding equality X=X and Y=Y′ between samples to find positive pairs, instead thresholds δ,ϵ could be applied and X,X′ and Y,Y′ considered “close” if |X−X|≤δ and |Y−Y′|≤ϵ. Additionally, one could also first learn a low-dimensional representation g(.) of X and consider X,X′ close if |g(X)−g(X)|≤δ. Indeed, for continuous g(.), if g(X),g(X′) are close, so too are X,X′. In this setting, samples [X,T,Y],[X,T,Y′] with: |g(X)−g(X′)|≤δ and |Y−Y′|≤ϵ also have similar T_{C} and T_{C}′. Indeed, |ƒ(T_{C},X)−ƒ(T_{C}′,X)|=|Y−Y′|≤ϵ. For continuous g(.) with |g(X)−g(X′)|≤δ, there exists a ρ such that

$$X \approx {X}^{′} + ρ . f ( {T}_{C}^{′} , {X}^{′} ) = f ( {T}_{C}^{′} , X + ρ ) \approx f ( {T}_{C}^{′} , X )$$

by Taylor expanding smooth ƒ(.) with small ρ. This implies |ƒ(T_{C},X)−ƒ(T_{C}′,X)|≤ϵ,∀X. For smooth ƒ(.), T_{C} and T′_{C} are thus close. If, instead, |Y−Y′|>ϵ, then T_{C} and T_{C}′ would not be close, which provide a set of negative samples. Hence a contrastive approach with such positive and negative pairs should still push T's with similar T_{C}'s together, and dissimilar T_{C}'s apart.

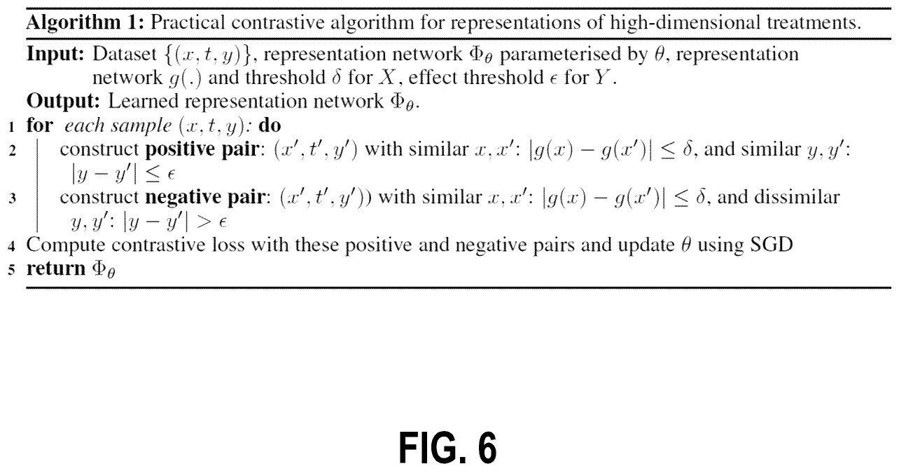

FIG. 6 depicts Algorithm 1, which describes an example of this practical contrastive approach to learn representations of multi-dimensional treatments, which was empirically validated on synthetic and real data as described below.

This contrastive approach makes a causal effect estimation model more robust to non-causal information present in multi-dimensional treatments used to train the model. Non-causal information presents a crucial risk to machine learning models. A model fails to discard non-causal information due to two types of errors: irreducible and reducible errors. In other words, error due imperfect information among covariates and treatment; or due to the inability of the learning mechanism to model the problem correctly. Regardless of the type of error, a causal model should discard all non-causal information.

A common characteristic among each of the datasets used in the experiments described herein is that, similarly to FIG. 4, multidimensional treatments are constructed from causal and non-causal information. The goal was to evaluate that the model is able to discard non-causal information and retain causal information. To add complexity through irreducible error, a synthetic dataset was used, generated via a DAG as described in FIG. 4. This synthetic dataset had 1000 samples (70% for training and 30% for evaluation); the treatment variable had 10 dimensions, 5 were causal and 5 were non-causal, both highly correlated with the covariates; the outcome was causally determined by the covariates, the causal part of the treatment, and random noise. To introduce complexity through reducible additional error datasets were used. These datasets have more complex causal relations than the synthetic dataset and a large part of the error should be reducible by the model.

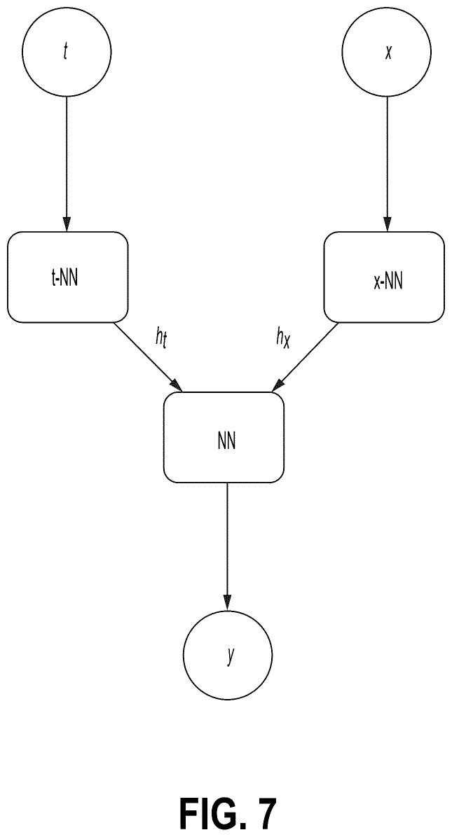

When evaluating the embodiments described herein, the contrastive method was applied to a classical CATE model (specifics described below, general structure depicted in FIG. 7), which applied the treatment and covariate inputs to respective neural networks to generate respective outputs which were, themselves, applied as inputs to a third neural network to generate the predicted output. The contrastive loss used was the triplet loss. Positive and negative pairs were selected using a simple clustering method as the function g from above, with each component of the variable being bucketed, thus converting continuous variables into discrete ones. The contrastive CATE model was compared to two baselines; the same CATE model without the use of the contrastive loss during learning, and the SIN model (described below). The CATE model, with and without the contrastive loss, was implemented as a linear model for the first set of experiments. As a representation of the treatment was needed to compute the contrastive loss, this was computed by applying the treatment weights of the model onto the treatment, and the outcome of this operation was the representation used. For the second set of experiments, the CATE model was implemented as a neural network with treatment and covariate branches producing their respective representations.

In order to measure the robustness introduced by the contrastive approach, the models' ability to learn to solve the given problem under no perturbations was assessed. For this purpose the mean absolute error (MAE) and root mean squared error (RMSE) for unperturbed test data was calculated. Once all models had learned to solve the task, the ability of the model to ignore non-causal information present in the treatment variable was assessed. To this end, the experiments below computed the RMSE between the effects of two treatments (t,t′)

$$\sqrt{\frac{1}{n} \sum {[ ( f ( x , t ) - f ( x , {t}^{′} ) ) - ( y - {y}^{′} ) ]}^{2}}$$

where ƒ is the model and y,y′ are the true outcomes. When t and t′ come from the same t_{C} but with different t_{nC}, this metric provides a measure of how robust the model is to changes in non-causal information, thus measuring the degree to which the model ignores non-causal information.

A common source of error in machine-learning models is due to the lack of information in their inputs. Problems with imperfect information can make the model rely on correlations instead of the true causal relations between treatment, covariates, and outcome. This experiment assessed if the contrastive method described herein made the model more robust to this kind of error. To this end, the synthetic dataset was perturbed by adding additional noise to the outcome before training. The added noise came from a normal distribution with mean zero and its standard deviation increased linearly in steps of 0.1 starting at 0.0 up to 1.0. Note that due to the learning mechanism used, a model may incorrectly rely on correlations between the treatment and covariates, even without intervening in these variables.

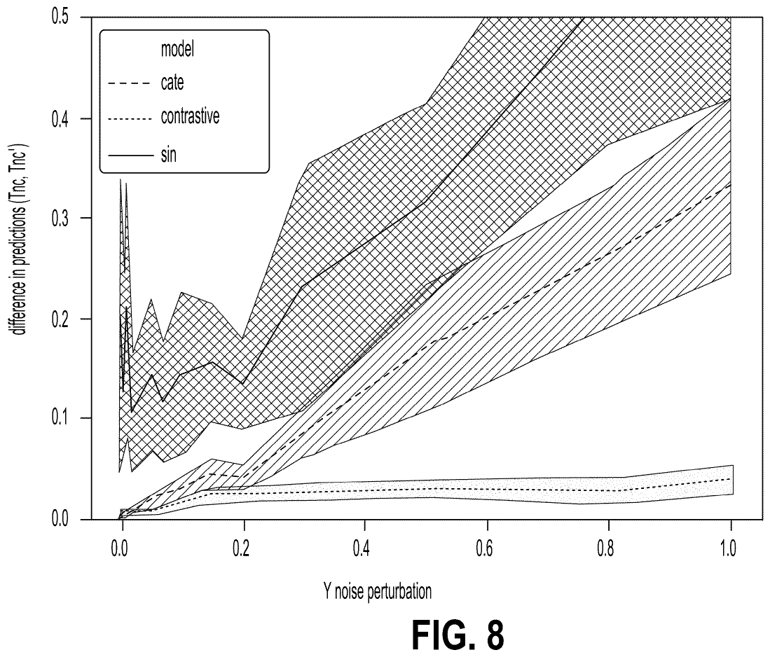

An ideal model would predict the same outcome regardless of the non-causal information in the treatment (t_{nC}), since this information does not causally influence the outcome. The experimental results depicted in FIG. 8 illustrate the difference in predictions (the effect) between a sample (x,t,y) and a perturbed version of the treatment (x,t′,y) where/only has its t_{nC′} component changed. The contrastive method described herein achieves, to a reasonable degree, that effect; but the CATE and SIN models failed to do so.

### VII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
obtaining a plurality of training examples, wherein each training example of the plurality of training examples includes a first input, a second input, and an output, wherein the first input is multi-dimensional;
identifying an anchor training example, a positive training example, and a negative training example of the plurality of training examples by:
applying the second inputs of the anchor training example, positive training example, and negative training example to a mapping function to generate respective mapped inputs,
determining that a first difference between the respective mapped inputs of the anchor training example and the positive training example is less than a first threshold value,
determining that a second difference between the outputs of the anchor training example and the positive training example is less than a second threshold value,
determining that a third difference between the respective mapped inputs of the anchor training example and the negative training example is less than the first threshold value, and
determining that a fourth difference between the outputs of the anchor training example and the negative training example is greater than the second threshold value;
applying the first and second inputs of the anchor training example, the positive training example, and the negative training example to a machine learning model to determine a contrastive loss; and
updating the machine learning model based on the contrastive loss.

2. The computer-implemented method of claim 1, wherein the first input represents digital audio content, and wherein the second input identifies a user account from a set of user accounts.

3. The computer-implemented method of claim 2, wherein the first input includes a plurality of features representative of digital audio content.

4. The computer-implemented method of claim 1, wherein updating the machine learning model based on the contrastive loss comprises updating the machine learning model such that predicted outputs of the machine learning model for the anchor training example and positive training example are less different and further such that predicted outputs of the machine learning model for the anchor training example and negative training example are more different.

5. The computer-implemented method of claim 4, wherein determining the contrastive loss comprises:
applying the first inputs and the second inputs of the anchor training example, positive training example, and negative training example to the machine learning model to generate respective predicted outputs; and
determining the contrastive loss based on the predicted outputs,
wherein the method further comprises determining a reconstructive loss based on the output and predicted output for the anchor training example, and wherein updating the machine learning model based on the contrastive loss comprises updating the machine learning model based on the contrastive loss and the reconstructive loss.

6. The computer-implemented method of claim 5, wherein determining the contrastive loss based on the predicted outputs comprises determining whether a magnitude of a first difference between the predicted outputs for the anchor training example and the positive training example is less than a magnitude of a second difference between the predicted outputs for the anchor training example and the negative training example.

7. The computer-implemented method of claim 1, further comprising, after updating the machine learning model based on the contrastive loss:
determining at least one aspect of the first input that the machine learning model relies on less than a threshold amount to generate a model output; and
modifying the machine learning model to exclude use of the determined at least one aspect of the first input to generate the model output.

8. The computer-implemented method of claim 1, wherein the mapping function comprises a clustering function.

9. The computer-implemented method of claim 1, wherein the mapping function comprises a nonlinear function that projects a multi-dimensional input to a scalar output.

10. The computer-implemented method of claim 1, wherein the first input is representative of a first set of variables and a second set of variables, wherein a variable represented by the second input has a causal effect on the first set of variables, the second set of variables, and the output, and wherein the first set of variables has a causal effect on the output that is greater than a causal effect on the output by the second set of variables.

11. A computer-implemented method comprising:
applying a first input and a second input to a trained machine learning model to generate a model output, wherein the first input is multi-dimensional, and wherein the trained machine learning model has been trained by:
obtaining a plurality of training examples, wherein each training example of the plurality of training examples includes a third input, a fourth input, and an output, wherein the third input is multi-dimensional;
identifying an anchor training example, a positive training example, and a negative training example of the plurality of training examples by:
applying the fourth inputs of the anchor training example, positive training example, and negative training example to a mapping function to generate respective mapped inputs,
determining that a first difference between the respective mapped inputs of the anchor training example and the positive training example is less than a first threshold value,
determining that a second difference between the outputs of the anchor training example and the positive training example is less than a second threshold value,
determining that a third difference between the respective mapped inputs of the anchor training example and the negative training example is less than the first threshold value, and
determining that a fourth difference between the outputs of the anchor training example and the negative training example is greater than the second threshold value;
applying the third and fourth inputs of the anchor training example, the positive training example, and the negative training example to a machine learning model to determine a contrastive loss; and
updating the machine learning model based on the contrastive loss to generate the trained machine learning model.

12. The computer-implemented method of claim 11, wherein the first input represents digital audio content, and wherein the second input identifies a user account from a set of user accounts.

13. The computer-implemented method of claim 12, wherein the first input includes a plurality of features representative of digital audio content.

14. The computer-implemented method of claim 11, wherein updating the machine learning model based on the contrastive loss comprises updating the machine learning model such that predicted outputs of the machine learning model for the anchor training example and positive training example are less different and further such that predicted outputs of the machine learning model for the anchor training example and negative training example are more different.

15. The computer-implemented method of claim 14, wherein determining the contrastive loss comprises:
applying the third inputs and the fourth inputs of the anchor training example, positive training example, and negative training example to the machine learning model to generate respective predicted outputs; and
determining the contrastive loss based on the predicted outputs,
wherein the method further comprises determining a reconstructive loss based on the output and predicted output for the anchor training example, and wherein updating the machine learning model based on the contrastive loss comprises updating the machine learning model based on the contrastive loss and the reconstructive loss.

16. The computer-implemented method of claim 15, wherein determining the contrastive loss based on the predicted outputs comprises determining whether a magnitude of a first difference between the predicted outputs for the anchor training example and the positive training example is less than a magnitude of a second difference between the predicted outputs for the anchor training example and the negative training example.

17. The computer-implemented method of claim 11, wherein training the trained machine learning model further comprises, after updating the machine learning model based on the contrastive loss:
determining at least one aspect of the third input that the machine learning model relies on less than a threshold amount to generate a model output; and
modifying the machine learning model to exclude use of the determined at least one aspect of the third input to generate the model output.

18. The computer-implemented method of claim 11, wherein the mapping function comprises a clustering function.

19. The computer-implemented method of claim 11, wherein the mapping function comprises a nonlinear function that projects a multi-dimensional input to a scalar output.

20. A non-transitory computer-readable medium, having stored thereon program instructions that, upon execution by a computing system, cause the computing system to perform operations comprising:
identifying, from a plurality of training examples, an anchor training example, a positive training example, and a negative training example of the plurality of training examples, wherein each training example of the plurality of training examples includes a first input, a second input, and an output, wherein the first input is multi-dimensional, and wherein identifying the anchor training example, a positive training example, and a negative training example comprises:
applying the second inputs of the anchor training example, positive training example, and negative training example to a mapping function to generate respective mapped inputs,
determining that a first difference between the respective mapped inputs of the anchor training example and the positive training example is less than a first threshold value,
determining that a second difference between the outputs of the anchor training example and the positive training example is less than a second threshold value,
determining that a third difference between the respective mapped inputs of the anchor training example and the negative training example is less than the first threshold value, and
determining that a fourth difference between the outputs of the anchor training example and the negative training example is greater than the second threshold value;
applying the first and second inputs of the anchor training example, the positive training example, and the negative training example to a machine learning model to determine a contrastive loss; and
updating the machine learning model based on the contrastive loss.
